(19) United States
(12) Patent Application Publication
(10) Pub. No.: US 2026/0146486 A1
(43) Pub. Date: May 28, 2026

(54) UNVERSAL DOOR HINGE FOR VEHICLE, VEHICLE INCLUDING THE SAME, AND METHOD OF USING THE SAME

(71) Applicants: HYUNDAI MOTOR COMPANY, Seoul (KR); KIA CORPORATION, Seoul (KR)

(72) Inventors: Zuobin Li, Yantai (CN); Shi Long Song, Yantai (CN); Hai Liang Wang, Yantai (CN)

(73) Assignees: HYUNDAI MOTOR COMPANY, Seoul (KR); KIA CORPORATION, Seoul (KR)

(21) Appl. No.: 19/178,436

(22) Filed: Apr. 14, 2025

(30) Foreign Application Priority Data
Jun. 12, 2024 (CN) 202410756526.6

(51) Int. Cl. E05D 3/10; E05D 7/00

(52) U.S. Cl. CPC E05D 3/10; E05D 7/00; E05Y 2900/531

(57) ABSTRACT

A universal door hinge for a vehicle and a method of using the universal door hinge for the vehicle. The universal door hinge includes: a hinge assembly; an upper rotation assembly; and a lifting assembly. In particular, the hinge assembly includes a rotation plate including a first rotation pin hole formed therein and a hinge arm including a differently-shaped bolt hole formed therein. The upper rotation assembly includes a rotation pin capable of passing through the first rotation pin hole of the hinge assembly to rotatably couple the hinge assembly to the upper rotation assembly. The lifting assembly includes a differently-shaped bolt capable of passing through the differently-shaped bolt hole of the hinge arm to couple the lifting assembly to the hinge assembly.

### CROSS-REFERENCE TO RELATED APPLICATION

This application claims priority to and the benefit of Chinese Patent Application No. 202410756526.6, filed with the Chinese Intellectual Property Office on Jun. 12, 2024, the entire contents of which are incorporated herein by reference.

### BACKGROUND

### (a) Field

The present disclosure relates to a door hinge, and more particularly, to a universal door hinge for a vehicle, a vehicle including the same, and a method of using the same.

### (b) Description of the Related Art

An existing vehicle door may be classified into a swing door, an opposing swing door, a scissor door, a gull-wing door, or the like based on an opening type. A passenger vehicle generally employs the swing door. Recently, customized vehicle designs have been becoming increasingly diverse, and customized vehicle door designs have also been steadily growing, thus making the scissor door increasingly popular.

The scissor door may be opened vertically and has only one support point. The scissor door is different from a conventional swing door, which opens outward. From a functional perspective, the scissor door opens upward along a hinge on both sides of a vehicle body, thus making it more convenient for a passenger to get in and out of the vehicle than a regular vehicle door, while also requiring less external space to open.

However, the specifications of the hinge vary depending on various door designs, which may increase the complexity of structural engineering and production costs. In addition, a conventional hinge for the scissor door may only open the door in a scissor-like manner, and is incapable of implementing another opening type such as a wing-type opening. In order to switch a scissor-door-type opening to a swing-door-type opening, the hinge is required to be replaced with a new door hinge.

The above information disclosed in this Background section is provided only to assist in a better understanding of the background of the present disclosure, and may therefore include information that is not a part of the prior art already known to those having ordinary skill in the art to which the present disclosure pertains.

### SUMMARY

The present disclosure provides a universal door hinge for a vehicle that may implement switching between a scissor door and a swing door.

An embodiment of the present disclosure provides a universal door hinge for a vehicle including a door and a vehicle body. The universal door hinge may include: a hinge assembly; a rotation assembly (e.g., an upper rotation assembly); and a lifting assembly. The hinge assembly includes a rotation plate including a first rotation pin hole formed in the rotation plate and a hinge arm including a differently-shaped fastener hole (i.e., a first fastener hole) formed in the hinge arm, the rotation assembly includes a rotation pin capable of passing through the first rotation pin hole of the hinge assembly to rotatably connect the hinge assembly to the rotation assembly, and the lifting assembly includes a differently-shaped fastener (i.e., a first fastener) capable of passing through the first fastener hole of the hinge arm to connect the lifting assembly to the hinge assembly. When the door is a scissor-door, the hinge assembly is mounted to the door, the rotation assembly and the lifting assembly are mounted to the vehicle body, the hinge assembly is rotatably connected to the rotation assembly, and the lifting assembly is connected to the hinge assembly to push the door to be rotated upward and outward. When the door is a swing-door mode, the rotation assembly and lifting assembly of the universal door hinge are removed from the universal door hinge, and a bolt (i.e., a second fastener) is inserted into the first rotation pin hole of the hinge assembly to fix the rotation plate of the hinge assembly to the vehicle body, and a bolt (i.e., a third fastener) is inserted into the first fastener hole of the hinge assembly to fix the hinge arm of the hinge assembly to the door, thereby hingedly connecting the door to the vehicle body through the hinge assembly.

The hinge assembly may further include a hinge shaft, the rotation plate may include a connecting portion and a hinge portion. In particular, the hinge portion includes a hinge sleeve formed at an end of the hinge portion, the connecting portion includes the first rotation pin hole and a second fastener hole formed in the connecting portion, the hinge arm may include a mounting plate and a hinge base. The mounting plate includes the first fastener hole and a third fastener hole formed in the moutning plate, wherein a shape of the first fastener hole is different from a shape of the second and third fastener holds. The hinge shaft may rotatably connect the rotation plate to the hinge arm by passing through the hinge base of the hinge arm and the hinge sleeve of the rotation plate.

A bush may be disposed between the hinge shaft and the hinge base.

In another embodiment, the rotation assembly may further include: a fixed plate including a second rotation pin hole formed at a middle portion of the fixed plate and a fourth fastener hole formed at at least one end of the fixed plate such that the fixed plate is mounted to the vehicle body by inserting a third fastener into the fourth fastener hole. The rotation pin is configured to be into the second rotation pin hole of the fixed plate and the first rotation pin hole of the rotation plate such that the hinge assembly and the rotation assembly are rotatably coupled to each other.

The rotation assembly may include a bush mounted on each of the fixed plate and the rotation plate, and a pad disposed between the fixed plate and the rotation plate.

In an embodiment, the lifting assembly may further include a pneumatic cylinder, an upper spherical joint, a lower spherical joint, a lower bracket, and an upper bracket. The pneumatic cylinder may include a cylinder barrel and a piston. In particular, the cylinder barrel includes a lower mounting joint provided at one end of the cylinder barrel, and the piston includes an upper mounting joint formed at an end of the piston. The upper spherical joint may include a first spherical portion formed at one end of the upper spherical joint, and the first spherical portion is connected to the upper mounting joint of the piston to configure a spherical hinge. The lower spherical joint may include a second spherical portion formed at one end of the lower spherical joint, and the second spherical portion is connected to the lower mounting joint of the cylinder barrel to configure a spherical hinge. The lower bracket may include a mounting portion and a bent portion bent relative to the mounting portion. The mounting portion includes a fifth fastener hole formed in the mounting portion, the bent portion includes a first opening formed in the bent portion, and the lower spherical joint is mounted in the first opening. The upper spherical joint may be mounted to the upper bracket, and the first fastener may include a screw thread formed at one end of the first fastener and a socket portion formed at the other end of the first fastener. In particular, the screw thread is connected to the door by passing through the first fastener hole of the hinge arm, and the upper bracket is mounted to the socket portion.

The upper spherical joint may include a screw thread formed at the other end of the upper spherical joint, the lifting assembly may further include a connecting nut, the upper bracket may include a second opening formed in one end of the upper bracket, and the screw thread of the upper spherical joint may pass through the second opening and is threaded with the connecting nut to mount the upper spherical joint to the upper bracket.

The first fastener may further include a flange portion disposed at a middle portion of the first fastener, the flange portion is compressed against a surface of the hinge arm, and the socket portion may include a notch formed in the socket portion, the upper bracket being inserted into the notch.

The rotation plate may include a single first bolt hole formed in the rotation plate, and the hinge assembly may be mounted to the vehicle body by inserting a bolt into the first bolt hole and the rotation pin hole, and the hinge arm may include a single second bolt hole formed in the hinge arm, and the hinge assembly may be mounted to the door by inserting a bolt into the second bolt hole and the first fastener hole.

The rotation plate may include two first bolt holes formed in the rotation plate, and the hinge assembly may be mounted to the vehicle body by inserting the bolts into the first bolt holes, and the hinge arm may include two second bolt holes formed in the hinge arm, and the hinge assembly may be mounted to the door by inserting the bolts into the second bolt holes.

The hinge assembly may be mounted to the vehicle body, and the rotation assembly and the lifting assembly may be mounted to the door.

The vehicle body and the door may include openings for mounting the hinge assembly, the rotation assembly, and the lifting assembly, respectively.

According to another embodiment, provided is a vehicle including the universal door hinge for the vehicle described above.

According to yet another embodiment, a method of assembling a vehicle door and a vehicle body using the universal door hinge for the vehicle described above. The method includes: forming a first hole in the vehicle door to facilitate mounting of the hinge arm of the hinge assembly; forming a second hole in the vehicle body to facilitate mounting of the rotation assembly; forming a third hole in the vehicle body to facilitate mounting of the lifting assembly; forming a fourth hole in the vehicle body to facilitate mounting of the rotation plate of the hinge assembly; mounting the hinge assembly to the door by inserting a fastener and a differently-shaped fastener into the hinge arm and the first hole, mounting the upper rotation assembly to the door by inserting the fastener into the second hole, mounting the lifting assembly to the vehicle door by inserting the fastener into the third hole, and rotatably connecting the hinge assembly to the rotation assembly by using the rotation pin, when the universal door hinge is used as a door hinge for a scissor door; and mounting the hinge assembly to the vehicle door by inserting the fastener into the hinge arm and the first hole, and mounting the hinge assembly to the vehicle body by inserting the fastener into the rotation plate and the fourth hole, when the universal door hinge is used as a door hinge for a swing door.

The universal door hinge for the vehicle according to the present disclosure achieves the following advantageous effects.
(1) The universal door hinge for the vehicle according to the present disclosure may reduce the cost by sharing some members in implementing the two door opening types.

The scissor-door-type opening may be implemented when using the entire universal door hinge of the present disclosure, and the swing-door-type opening may be implemented when using only the hinge assembly of the universal door hinge according to the present disclosure. Therefore, the two door opening types may be implemented using one hinge structure, thereby reducing the production and replacement cost of the hinge.
(2) The two door opening types may reduce the cost by sharing some structures of the door and the vehicle body.

The mounting positions of the door and the vehicle body when the hinge assembly and upper rotation assembly of the universal door hinge according to the present disclosure are mounted in the swing-door mode may overlap with the mounting positions of the door and the vehicle body when the hinge assembly is mounted in the scissor-door mode, thus enabling the sharing of the reinforced metal member on the door and the vehicle body. Thereby, the cost may further reduced.
(3) The two door opening types are conveniently compatible.

If the door needs to be switched from the scissor door to the swing door, the upper rotation assembly and the lifting assembly of the universal door hinge according to the present disclosure may only be removed, and the door may be connected to the vehicle body by using only the hinge assembly, thereby configuring the hinge for the swing door. If the door needs to be switched from the swing door to the scissor door, the upper rotation assembly and the lifting assembly may be mounted to the vehicle body and connected to the hinge assembly.

In addition, an effect which may be acquired or predicted from the embodiments of the present disclosure is disclosed directly or implicitly in the detailed description of the embodiments of the present disclosure. That is, various effects predicted from the embodiments of the present disclosure are disclosed in the detailed description described below.

### BRIEF DESCRIPTION OF THE DRAWINGS

FIG. 1 is a schematic diagram of a universal door hinge for a vehicle according to an embodiment of the present disclosure.

FIG. 2 is an exploded schematic diagram of a universal door hinge for a vehicle according to an embodiment of the present disclosure.

FIG. 3A is an assembly diagram of a hinge assembly of a universal door hinge according to an embodiment of the present disclosure.

FIG. 3B is an exploded schematic diagram of a hinge assembly of a universal door hinge according to an embodiment of the present disclosure.

FIG. 4A is an assembly schematic diagram of a hinge assembly and an upper rotation assembly of the universal door hinge according to an embodiment of the present disclosure.

FIG. 4B is an exploded schematic diagram of an upper rotation assembly of a universal door hinge according to an embodiment of the present disclosure.

FIG. 5 is a front view of a hinge assembly and an upper rotation assembly of a universal door hinge according to an embodiment of the present disclosure.

FIG. 6 is a cross-sectional view taken along a line A-A in FIG. 5.

FIG. 7 is an exploded schematic diagram of a lifting assembly of a universal door hinge according to an embodiment of the present disclosure.

FIG. 8 is an assembly schematic diagram of an upper spherical joint, an upper bracket, and a differently-shaped bolt in a lifting assembly, according to an embodiment of the present disclosure.

FIG. 9 is an exploded schematic diagram of an upper spherical joint, an upper bracket, and a connecting nut in a lifting assembly, according to an embodiment of the present disclosure.

FIG. 10 is an exploded schematic diagram of an upper bracket and a differently-shaped bolt in a lifting assembly, according to an embodiment of the present disclosure.

FIG. 11 is an assembly schematic diagram of a hinge assembly, an upper rotation assembly, and a lifting assembly of a universal door hinge according to an embodiment of the present disclosure.

FIG. 12A is a schematic mounting perspective diagram of a universal door hinge according to an embodiment of the present disclosure.

FIG. 12B is a mounting plan view of a universal door hinge according to an embodiment of the present disclosure.

FIG. 12C is a mounting side view of a universal door hinge according to an embodiment of the present disclosure.

FIG. 13 is a schematic diagram showing a movement relationship among a hinge assembly, an upper rotation assembly, and a lifting assembly of a universal door hinge according to an embodiment of the present disclosure.

FIG. 14 is a schematic diagram of a hinge assembly included in a universal door hinge according to another embodiment of the present disclosure.

FIG. 15 is a schematic mounting diagram of a universal door hinge, a door, and a vehicle body according to an embodiment of the present disclosure.

Unless otherwise described, the same reference numbers or symbols refer to the same components throughout the drawings.

It should be understood that the drawings are simplified representations of each feature to illustrate a basic principle of the present disclosure and are not necessarily drawn to scale. A specific design feature disclosed in the present disclosure (e.g., including specific size, orientation, location, and shape) is partially determined by the specific intended applications and usage environments.

### DETAILED DESCRIPTION

Hereinafter, respective embodiments of the present disclosure are described in detail, and these embodiments are described below with reference to the accompanying drawings. Although the present disclosure is described with reference to the embodiments, it should be understood that the present disclosure is not limited to these embodiments. Rather, the present disclosure includes not only these embodiments, but also various alternatives, modifications, equivalents, and other embodiments within the scope of the present disclosure and the appended claims.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

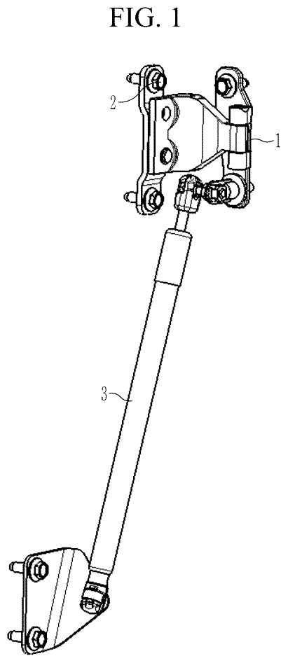

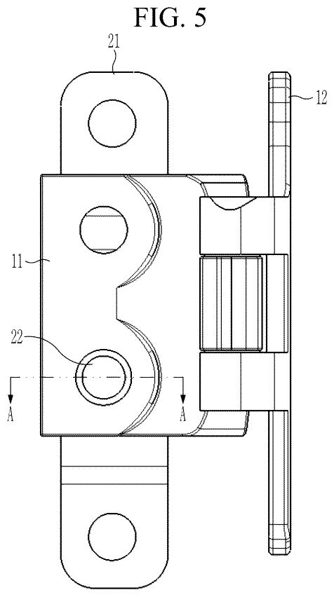

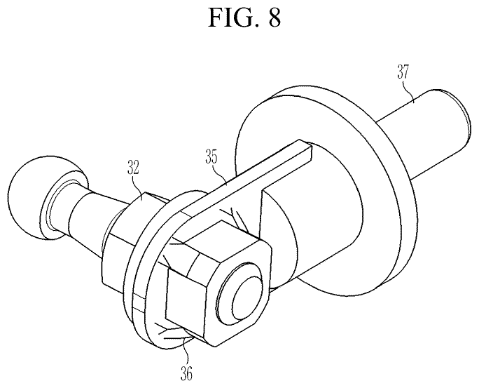

Hereinafter, a universal door hinge according to embodiments of the present disclosure is described with reference to FIGS. 1 to 14.

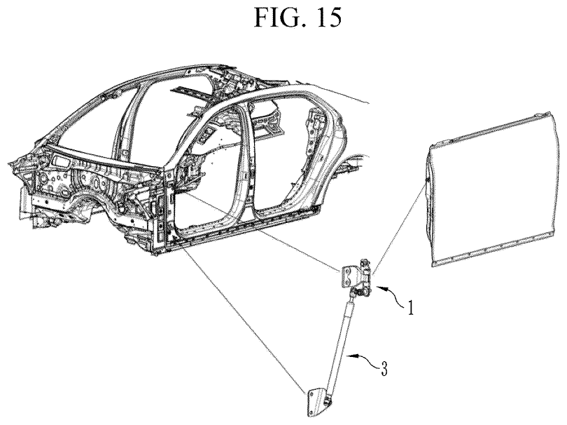

According to an embodiment of the present disclosure, referring to FIG. 1, a universal door hinge may include a hinge assembly 1, a rotation assembly (e.g., an upper rotation assembly) 2, and a lifting assembly 3. Referring to FIG. 15, the hinge assembly 1 may be mounted to a vehicle door, the rotation assembly 2 (hereinafter “the upper rotation assembly”) may be mounted to a vehicle body, and the lifting assembly 3 may also be mounted to the vehicle body. The hinge assembly 1 and the upper rotation assembly 2 may be rotatably connected to each other via a rotation pin 22, and the lifting assembly 3 may be connected to the hinge assembly 1, thereby providing power for opening the door.

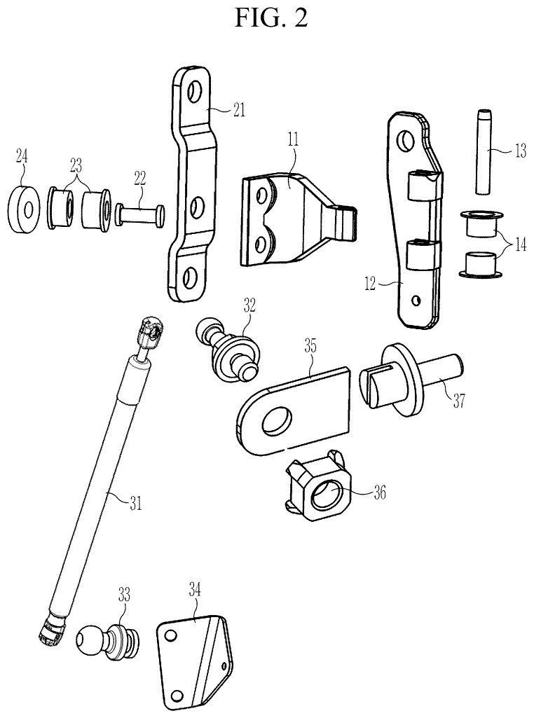

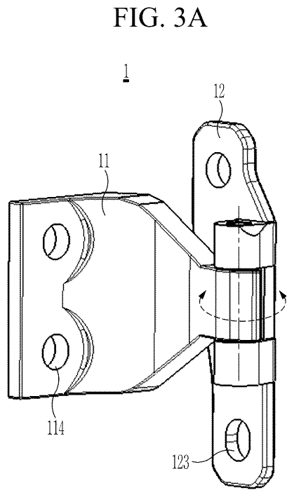

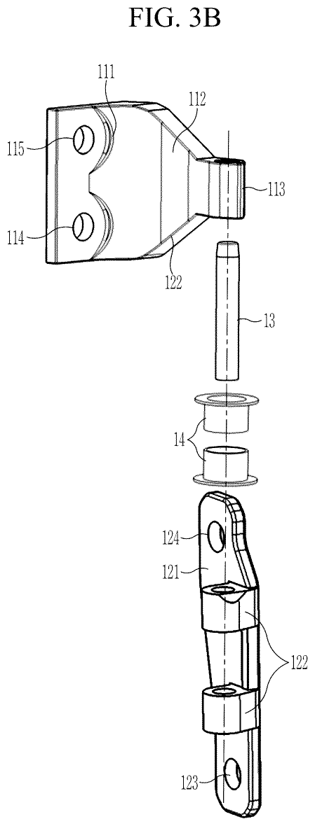

Referring to FIGS. 2, 3A, and 3B, the hinge assembly 1 may include a rotation plate 11, a hinge arm 12, and a hinge shaft 13.

The rotation plate 11 may be an L-shaped plate including a connecting portion 111 and a hinge portion 112 bent from the connecting portion 111. Here, the hinge portion 112 may include a hinge sleeve 113 disposed at an end to mount the hinge shaft 13 therein. The connecting portion 111 may include openings 114 and 115 formed therein. In this embodiment, the rotation plate 11 may include two openings 114 and 115 formed therein, one of the two openings may be a rotation pin hole 114, and the other of the two openings may be a fastener hole (referred to hereinafter as a bolt hole, by way of example) 115. A plurality of fastener holes (e.g., bolt holes) may be provided as needed. A portion of the rotation plate 11 in which the openings are formed may be integrally formed as a thickened portion to increase a strength of the portion in which the openings are formed.

In this embodiment, the rotation pin hole 114 of the rotation plate 11 may be used as either the rotation pin hole or the fastener hole (e.g., the bolt hole). If the type of door is a scissor-door, the rotation pin 22 may be mounted in the rotation pin hole 114 to enable the hinge assembly 1 to rotate relative to the upper rotation assembly 2. In this case, the bolt hole 115 may not be used. If the type of door is a swing-door, the upper rotation assembly 2 may be removed from a vehicle body portion, and simultaneously, the rotation pin 22 may also be removed from the rotation pin hole 114, and two fastener M (referred to hereinafter as bolts, by way of example) may respectively pass through the rotation pin hole 114 and the bolt hole 115 to mount the hinge assembly 1 to the vehicle body. Here, the hinge assembly 1 may be used as a hinge for the swing door.

In other words, when the door needs to be switched from a scissor door to the swing door, the door may be hinged to the vehicle body by removing only the upper rotation assembly 2 connected to the vehicle body, and inserting the two bolts M into the rotation pin hole 114 and the bolt hole 115 in the rotation plate 11, thereby mounting the rotation plate 11 to the vehicle body. Accordingly, the door may be switched from the scissor door to the swing door.

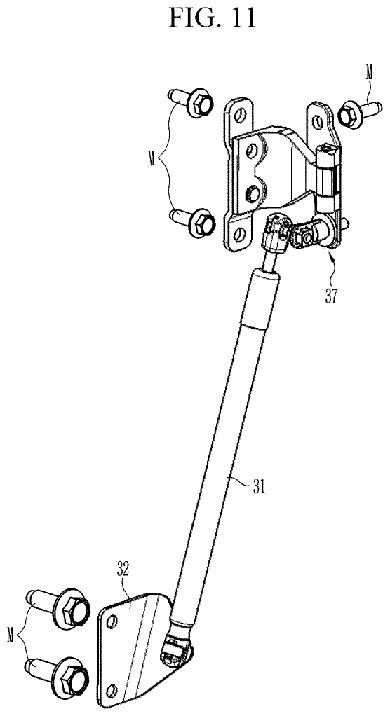

Referring to FIG. 3B, the hinge arm 12 may include a mounting plate 121 and a hinge base 122. The mounting plate 121 may include openings 123 and 124 formed therein. In this embodiment, the hinge arm 12 may include two openings 123 and 124 formed therein. One opening (e.g., a first opening or a first fastener hole) of the two openings may be a differently-shaped fastener hole (referred to hereinafter as a differently-shaped bolt hole, by way of example) 123 and the other of the two openings may be a fastener hole (referred to hereinafter as a bolt hole) 124. In other words, one of the two openings may be a bolt hole 123 having a different shape, and the other may be a standard bolt hole 124. Referring to FIG. 11, a differently shaped fastener 37 (e.g., a bolt) and the bolt M may pass through the differently shaped bolt hole 123 and the bolt hole 124, respectively, to mount the hinge arm 12 to the door. As illustrated in FIG. 3B, two hinge bases 122 may be provided, and a gap may be formed between the two hinge bases 122 to allow the hinge sleeve 113 of the rotation plate 11 to be inserted into the gap.

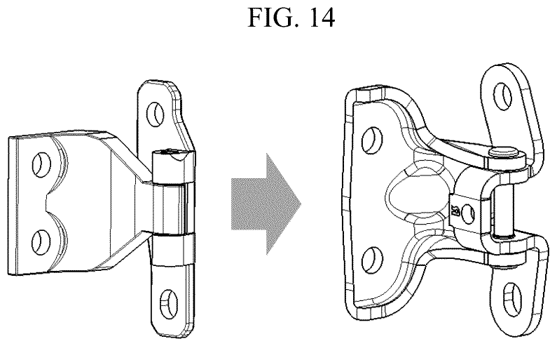

In the above embodiment, the rotation plate 11 and the hinge arm 12 used in the hinge assembly 1 are forged members. However, these members may be replaced with punched members (see FIG. 14). It is thus possible to reduce processing cost.

The hinge shaft 13 may pivotally connect the rotation plate 11 to the hinge arm 12 by simultaneously passing through the hinge base 122 of the hinge arm 12 and the hinge sleeve 113 of the rotation plate 11. Therefore, the rotation plate 11 may be rotated around an axis line of the hinge shaft 13. As illustrated in FIG. 3B, a bush 14 may be mounted on each of the two ends of the hinge shaft 13, and the bush 14 may be disposed between the hinge shaft 13 and the hinge base 122 to reduce friction and noise.

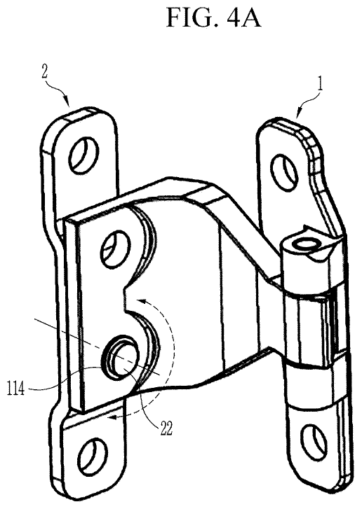

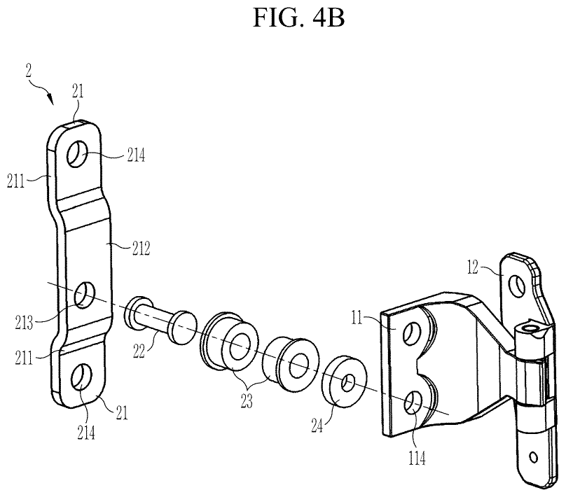

Referring to FIGS. 2, 4A, and 4B, the upper rotation assembly 2 may include a fixed plate 21 and the rotation pin 22. The door may be rotated upward by the upper rotation assembly 2.

The fixed plate 21 may have a plate-shaped structure including an end 211 disposed on each of two sides (e.g., opposite sides) of the fixed plate 21 and a protrusion 212 disposed in the middle portion of the fixed plate 21.

The protrusion 212 may be formed to protrude away from the vehicle body, thereby creating a space between the protrusion and the vehicle body, and the space may accommodate an end portion of the rotation pin 22. The protrusion 212 may include one rotation pin hole 213 formed therein, and the rotation pin 22 may pass through the rotation pin hole 213.

A bolt hole 214 may formed in each end 211 disposed on the opposite sides of the fixed plate 21, and the bolt M may pass through the bolt hole 214 to mount the fixed plate 21 to the vehicle body.

The rotation pin 22 may rotatably connect the fixed plate 21 to the rotation plate 11 by passing through the rotation pin hole 213 of the fixed plate 21 and the rotation pin hole 114 of the rotation plate 11.

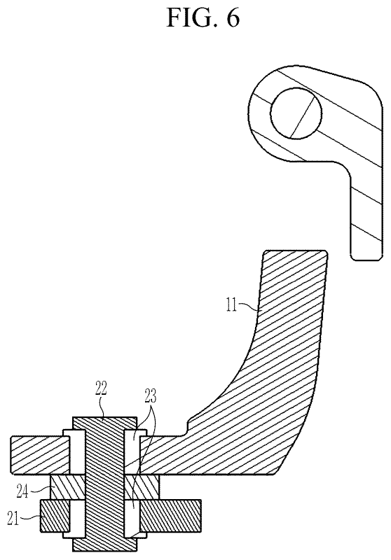

Referring to FIG. 6, the upper rotation assembly 2 may further include two bushes 23 mounted on the fixed plate 21 and the rotation plate 11, respectively, to reduce friction and wear between the fixed plate 21, the rotation plate 11, and the rotation pin 22. When the bush 23 is worn, replacement of the bush 23 may restore the coupling between the fixed plate 21, the rotation plate 11 and the rotation pin 22. A pad 24 may be further disposed between the fixed plate 21 and the rotation plate 11 to reduce a frictional resistance between the fixed plate 21 and the rotation plate 11.

Referring to FIG. 11, the lifting assembly 3 may have one end mounted on the vehicle body and the other end connected to the hinge assembly 1, and when a pneumatic cylinder 31 of the lifting assembly 3 extends outward, the pneumatic cylinder 31 may push the door to be opened upward and outward.

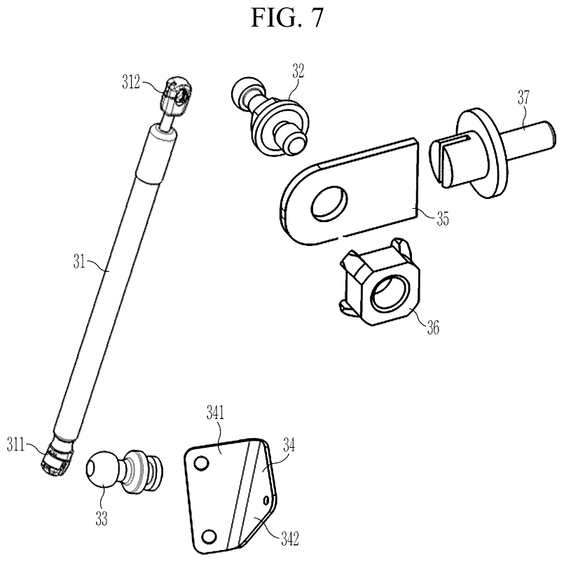

Referring to FIGS. 2 and 7, the lifting assembly 3 may include the pneumatic cylinder 31, an upper spherical joint 32, a lower spherical joint 33, a lower bracket 34, an upper bracket 35, a connecting nut 36, and the differently shaped bolt 37.

The pneumatic cylinder 31 may include a cylinder barrel and a piston. The cylinder barrel may include a lower mounting joint 311 disposed at one end, and the lower mounting joint 311 may be connected to the lower spherical joint 33 to form a gimbal rotation mechanism. The piston may include an upper mounting joint 312 disposed at an end, and the upper mounting joint 312 may be connected to the upper spherical joint 32 to form a gimbal rotation mechanism. The above pneumatic cylinder 31 may function to provide door-opening power to the hinge assembly 1 by a movement of the piston included in the pneumatic cylinder 31 when the door is opened. Although this embodiment illustrates the use of a pneumatic cylinder, other driving mechanism, such as a driving mechanism driven by a motor, may also be used.

One end of the lower spherical joint 33 may be formed as a sphere and configure a spherical hinge with the lower mounting joint 311 of the cylinder barrel, and the other end of the lower spherical joint 33 may be mounted on the lower bracket 34.

The lower bracket 34 may be an L-shaped plate including a mounting portion 341 and a bent portion 342, and the bent portion 342 may be bent about 90 degrees relative to the mounting portion 341. The mounting portion 341 may include two bolt holes formed therein, and the bolt M may pass through the bolt hole to fix the lower bracket 34 to the vehicle body. The bent portion 342 may include an opening formed therein, and the lower spherical joint 33 may be mounted in the opening.

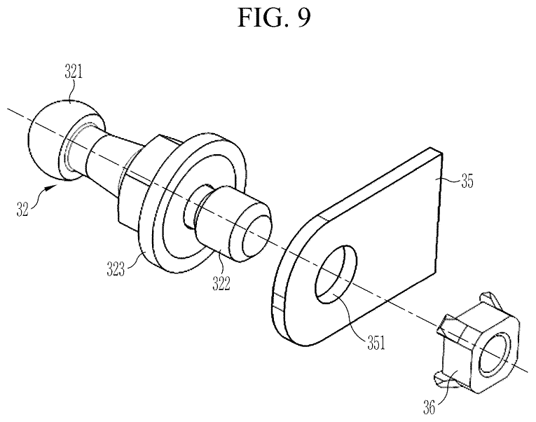

Referring to FIG. 9, the upper spherical joint 32 may include a spherical portion 321 formed at one end, and the spherical portion 321 may configure the spherical hinge with the upper mounting joint 312 of the piston. The upper spherical joint 32 may include a screw thread 322 formed at the other end, and the screw thread 322 may be mounted to the upper bracket 35 through the connecting nut 36. A flange 323 may be formed in a middle portion of the upper spherical joint 32, and the flange 323 may be compressed against a side surface of the upper bracket 35 through a screw-coupling between the connecting nut 36 and the screw thread 322 of the upper spherical joint 32, thereby mounting the upper spherical joint 32 to the upper bracket 35.

The connecting nut 36 may be fixed to the upper bracket 35 by welding.

The upper bracket 35 may be a plate and include an opening 351 formed in one end portion of the upper bracket 35. The screw thread 322 of the upper spherical joint 32 may be screwed with the connecting nut 36 by passing through the opening 351. The other end of the upper bracket 35 may be inserted into the different-shaped bolt 37.

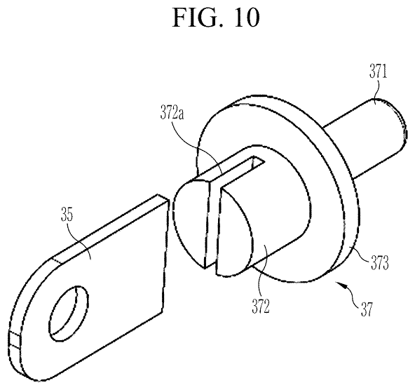

Referring to FIG. 10, the different-shaped bolt 37 may include a screw thread 371 formed at one end, a socket portion 372 formed at the other end, and a flange portion 373 disposed at a middle portion. The screw thread 371 may be fixedly connected to the door by passing through the different-shaped bolt hole 123 of the hinge arm 12. The flange portion 373 may be compressed against a surface of the hinge arm 12. The socket portion 372 may include a notch 372a formed therein, and the upper bracket 35 may be inserted into the notch 372a and fixedly connected to the different-shaped bolt 37 by welding.

Hereinafter, an operation process of the universal door hinge according to an embodiment of the present disclosure will be described.

The universal door hinge according to an embodiment of the present disclosure may be used as a door hinge for the scissor door or as a door hinge for the swing door, and one door hinge may thus be used as the door hinge for two door opening and closing types.

When the universal door hinge according to an embodiment of the present disclosure is used as the door hinge for the scissor door, the hinge assembly 1 may be mounted to the door, the upper rotation assembly 2 may be mounted to the vehicle body, and the hinge assembly 1 and the upper rotation assembly 2 may be connected to each other by using the rotation pin 22. The rotation pin 22 may pass through the rotation pin hole 114 of the rotation plate 11 included in the hinge assembly 1 and the rotation pin hole 213 of the fixed plate 21 included in the upper rotation assembly 2. The lifting assembly 3 may be mounted to the vehicle body, and the different-shaped bolt 37 of the lifting assembly 3 may pass through the different-shaped bolt hole 123 of the hinge arm 12 included in the hinge assembly 1 to configure the door hinge for the scissor door.

When the universal door hinge according to an embodiment of the present disclosure is used as the door hinge for the swing door, only the hinge assembly 1 may be used, and the upper rotation assembly 2 and the lifting assembly 3 may be removed. The bolt M may be inserted into the rotation pin hole 114 and the bolt hole 115 of the rotation plate 11 included in the hinge assembly 1 to connect the hinge assembly 1 to the vehicle body, and the bolt M may be inserted into the different-shaped bolt hole 123 and bolt hole 124 of the hinge arm 12 included in the hinge assembly 1 to connect the hinge assembly 1 to the door, thereby configuring the door hinge for the swing door.

### Mounting Positions of Upper Rotation Assembly and Lifting Assembly on Vehicle Body

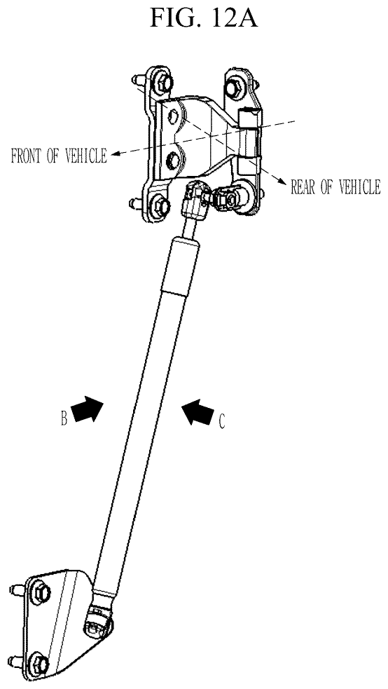

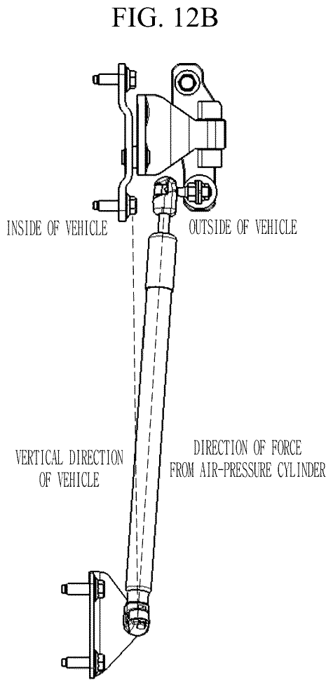

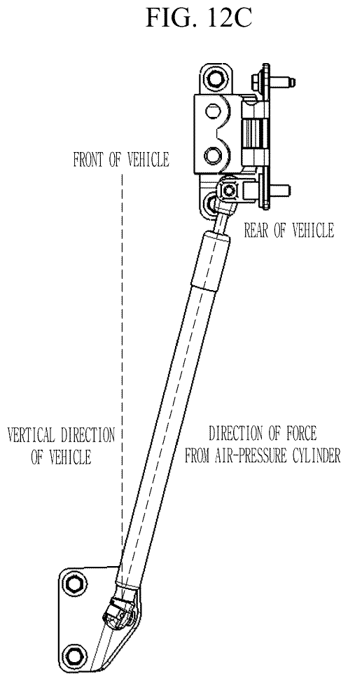

Referring to FIGS. 12A to 12C, the mounting positions of the upper rotation assembly 2 and the lifting assembly 3 on the vehicle body may not be disposed on the same straight lines in a transverse (width) direction and a vertical (length) direction of the vehicle body. Referring to the plan view in FIG. 12B, the fixed plate 21 and the lower mounting joint 311 may be disposed on the same straight line in the vertical direction of the vehicle body, and the pneumatic cylinder 31 may be offset toward the outside of the vehicle. Referring to the side view in FIG. 12C, the fixed plate 21 may be disposed behind the lower mounting joint 311 in the vertical direction of the vehicle body. Based on the above structure, when the piston of the pneumatic cylinder 31 extends, the pneumatic cylinder 31 may apply a thrust oriented toward the outside and the rear of the vehicle body, toward the door.

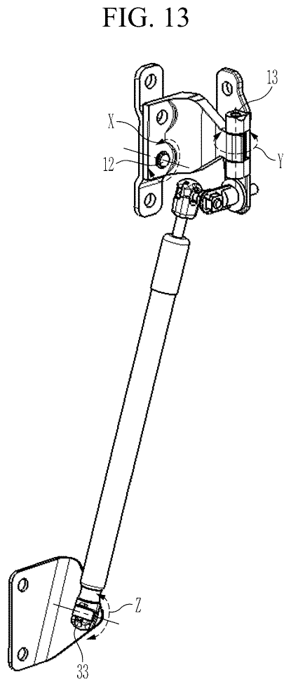

FIG. 13 shows a movement relationship among the hinge assembly, the upper rotation assembly, and the lifting assembly of the universal door hinge according to an embodiment of the present disclosure. When the universal door hinge according to an embodiment of the present disclosure is used as the door hinge for the scissor door, the hinge assembly 1 may be rotated around the rotation pin 22 of the upper rotation assembly 2 (see arrow X in FIG. 13), the hinge arm 12 of the hinge assembly 1 may be rotated around the hinge shaft 13 relative to the rotation plate 11 (see arrow Y in FIG. 13), and the pneumatic cylinder 31 may be rotated around the lower mounting joint 311 relative to the lower bracket 34 (see arrow Z in FIG. 13). When the door is opened, the piston of the pneumatic cylinder 31 may extend outward, and a force applied by the piston may be applied to the door through the different-shaped bolt 37. Accordingly, the door may be rotated upward around the rotation pin 22 and rotated outward around the hinge shaft 13. The door may be opened in the scissor-door mode by pushing force of the pneumatic cylinder 31.

In an embodiment of the present disclosure, the hinge assembly 1 may be mounted to the door, and the upper rotation assembly 2 and the lifting assembly 3 may be mounted to the vehicle body. However, the mounting positions of the assemblies may be switched. For example, the hinge assembly 1 may be mounted to the vehicle body, and the upper rotation assembly 2 and the lifting assembly 3 may be mounted to the door.

Those having ordinary skill in the art may modify an embodiment shown in this specification in accordance with the spirit of the present disclosure. For example, the rotation pin hole 114 of the rotation plate 11 included in the hinge assembly 1 may be provided as a dedicated hole for the rotation pin 22 rather than being used as the bolt hole for the swing door. In other words, the rotation plate 11 may include three openings formed therein. Here, the bolt hole may be disposed in each of two sides, and the rotation pin hole may be disposed in a middle portion. Therefore, the rotation pin hole may be disposed at the middle portion of the rotation plate, and accordingly, the hinge assembly 1 may be easily mounted even when sizes of the rotation pin and the bolt do not match each other. In addition, the different-shaped bolt hole 123 of the hinge arm 12 may be provided as a dedicated hole for the different-shaped bolt 37 rather than being used as the bolt hole for the swing door. In this case, the hinge arm 12 may include two bolt holes for mounting the hinge arm 12 to the door.

Hereinafter, mounting and mode changing processes of the universal door hinge according to an embodiment of the present disclosure will be described.

(I) Mounting Process of Door Hinge used for Scissor Door
First openings may be formed in the door, the first openings corresponding to the different-shaped bolt hole 123 and the bolt hole 124 of the hinge arm 12 included in the hinge assembly 1.
Second openings may be formed in the vehicle body, the second openings corresponding to the bolt holes 214 of the fixed plate 21 included in the upper rotation assembly 2, fourth openings may be formed in the vehicle body, the fourth openings corresponding to the rotation pin hole 114 and the bolt hole 115 of the rotation plate 11 included in the hinge assembly 1, and in this way, four openings may be formed in the vehicle body for the hinge assembly 1 and the upper rotation assembly 2.
Third openings may be formed in the vehicle body, the third openings corresponding to the bolt holes of the lower bracket 34 included in the lifting assembly 3.
The hinge assembly 1 may be mounted to the door by using the bolt M and the different-shaped bolt 37, the upper rotation assembly 2 may be mounted to the vehicle body by using the bolt M, and the lower bracket 34 of the lifting assembly 3 may be mounted to the vehicle body by using the bolt M.
The upper spherical joint 32 and the lower spherical joint 33 may be mounted to the upper bracket 35 and the lower bracket 34, respectively, and the pneumatic cylinder 31 may be mounted to the upper spherical joint 32 and the lower spherical joint 33.
In this way, the door hinge for the scissor door may be configured.

### (II) Process for Switching Door Hinge for Scissor Door to Door Hinge for Swing Door

The pneumatic cylinder 31 and the lower bracket 34 may be removed from the upper spherical joint 32 and the vehicle body.
The upper rotation assembly 2 may be removed from the vehicle body, and the rotation pin 22 may be removed from the rotation pin hole 114 of the rotation plate 11.
The different-shaped bolt 37 of the different-shaped bolt hole 123 included in the hinge arm 12 of the hinge assembly 1 may be replaced with the general bolt M.
The rotation plate 11 may be fixed to the vehicle body by inserting the bolt M into the rotation pin hole 114 and bolt hole 115 of the rotation plate 11 included in the hinge assembly 1.
In this way, the door hinge for the swing door may be configured.
   (III) Mounting Process of Door Hinge used for Swing Door
The hinge assembly 1 may be mounted to the door by inserting the bolt M into the different-shaped bolt hole 123 and the bolt hole 124 of the hinge arm 12 included in the hinge assembly 1.
The hinge assembly 1 may be mounted to the vehicle body by inserting the bolt M into the rotation pin hole 114 and bolt hole 115 of the rotation plate 11 included in the hinge assembly 1.
In this way, the door hinge for the swing door may be configured.

### (IV) Process for Switching Door Hinge for Swing Door to Door Hinge for Scissor Door

The hinge assembly 1 may be removed from the vehicle body by removing the bolt M from the rotation plate 11 included in the hinge assembly 1.
The lower bracket 34 of the lifting assembly 3 may be mounted to the vehicle body.
The lower spherical joint 33 may be mounted to the lower bracket 34.
The upper rotation assembly 2 may be connected to the hinge assembly 1 by inserting the rotation pin 22 into the rotation pin hole 114 of the rotation plate 11 included in the hinge assembly 1.
The upper rotation assembly 2 may be mounted to the vehicle body by using the bolt M.
The upper spherical joint 32 may be mounted to the upper bracket 35 by replacing the bolt M of the different-shaped bolt hole 123 included in the hinge arm 12 with the different-shaped bolt 37.
The upper spherical joint 32 and the lower spherical joint 33 may be mounted to the upper bracket 35 and the lower bracket 34, respectively, and the pneumatic cylinder 31 may be mounted to the upper spherical joint 32 and the lower spherical joint 33.
In this way, the door hinge for the scissor door may be configured.

The present disclosure achieves the following advantageous effects.
(1) The universal door hinge for the vehicle according to the present disclosure may reduce cost by sharing some members in implementing the two door opening types.

The scissor-door-type opening may be implemented when using the entire universal door hinge of the present disclosure, and the swing-door-type opening may be implemented when using only the hinge assembly 1 of the universal door hinge according to the present disclosure. Therefore, the two door opening types may be implemented using one hinge structure, thereby reducing the production and replacement cost of the hinge.
(2) The two door opening types may reduce the cost by sharing some structures of the door and the vehicle body.

The mounting positions of the door and the vehicle body when the hinge assembly 1 and upper rotation assembly 2 of the universal door hinge according to the present disclosure are mounted in the swing-door mode may overlap with the mounting positions of the door and the vehicle body when the hinge assembly 1 is mounted in the scissor-door mode, thus enabling the sharing of a reinforced metal member on the door and the vehicle body. Thereby, the cost may further reduced.
(3) The two door opening types are conveniently compatible.

If the door needs to be switched from the scissor door to the swing door, the upper rotation assembly 2 and the lifting assembly 3 of the universal door hinge according to the present disclosure may only be removed; the rotation pin 22 of the upper rotation assembly 2 may be replaced using the general bolt M; the rotation plate 11 may be mounted to the vehicle body by inserting the bolt M into the rotation pin hole 114 and bolt hole 115 of the rotation plate 11, thereby providing the hinged connection between the door and the vehicle body; and the different-shaped bolt 37 of the lifting assembly 3 may be replaced with the general bolt M. Accordingly, the door may be switched from the scissor door to the swing door. If the door needs to be switched from the swing door to the scissor door, the rotation plate 11 of the hinge assembly 1 may be removed from the vehicle body; the upper rotation assembly 2 may be mounted between the vehicle body and the hinge assembly 1 by replacing the bolt M of the rotation pin hole 114 with the rotation pin 22, and the lifting assembly 3 may be mounted between the vehicle body and the hinge assembly 1 by replacing the bolt M of the different-shaped bolt hole 123 included in the hinge arm 12 with the different-shaped bolt 37. Accordingly, the door may be switched from the swing door to the scissor door.

Although the specific embodiments of the present disclosure have been described hereinabove, the scope of the present disclosure is not limited thereto and includes all modifications and equivalents that may be easily made or recognized by those having ordinary skill in the art to which the present disclosure pertains.

What is claimed is:

1. A universal door hinge for a vehicle including a door and a vehicle body, the universal door hinge comprising:
a hinge assembly including:
a rotation plate including a first rotation pin hole, and
a hinge arm including a first fastener hole;
a rotation assembly including:
a rotation pin configured to pass through the first rotation pin hole of the hinge assembly and rotatably couple the hinge assembly to the rotation assembly; and
a lifting assembly including:
a first fastener configured to pass through the first fastener hole of the hinge arm to couple the lifting assembly to the hinge assembly,
when the door is a scissor-door, the hinge assembly is mounted to the door, the rotation assembly and the lifting assembly are mounted to the vehicle body, the hinge assembly is rotatably coupled to the rotation assembly, and the lifting assembly is coupled to the hinge assembly and configured to push the door to be rotated upward and outward, and
when the door is a swing-door, the rotation assembly and lifting assembly are configured to be removed from the universal door hinge, and a second fastener is configured to be inserted into the first rotation pin hole of the hinge assembly to fix the rotation plate of the hinge assembly to the vehicle body, and a third fastener is configured to be inserted into the first fastener hole of the hinge assembly to fix the hinge arm of the hinge assembly to the door, thereby hingedly connecting the door to the vehicle body through the hinge assembly.

2. The universal door hinge of claim 1, wherein:
the hinge assembly further includes a hinge shaft;
the rotation plate includes a connecting portion and a hinge portion;
the hinge portion includes a hinge sleeve formed at an end of the hinge portion, and the connecting portion includes the first rotation pin hole and a second fastener hole;
the hinge arm includes a mounting plate and a hinge base;
the mounting plate includes the first fastener hole and a third fastener hole, wherein a shape of the first fastener hole is different from a shape of the second and third fastener holds; and
the hinge shaft is configured to rotatably connect the rotation plate to the hinge arm by passing through the hinge base and the hinge sleeve.

3. The universal door hinge of claim 2, wherein a bush is disposed between the hinge shaft and the hinge base.

4. The universal door hinge of claim 2, wherein the rotation assembly further includes a fixed plate,
wherein the fixed plate includes:
a second rotation pin hole formed at a middle portion of the fixed plate; and
a fourth fastener hole formed at at least one end of the fixed plate such that the fixed plate is mounted to the vehicle body by inserting a third fastener into the fourth fastener hole, and
the rotation pin is configured to be inserted into the second rotation pin hole of the fixed plate and the first rotation pin hole of the rotation plate such that the hinge assembly and the rotation assembly are rotatably coupled to each other.

5. The universal door hinge of claim 4, wherein the rotation assembly includes:
a bush mounted on each of the fixed plate and the rotation plate, and
a pad disposed between the fixed plate and the rotation plate.

6. The universal door hinge of claim 2, wherein:
the lifting assembly further includes a pneumatic cylinder, an upper spherical joint, a lower spherical joint, a lower bracket, and an upper bracket,
the pneumatic cylinder includes a cylinder barrel and a piston,
the cylinder barrel includes a lower mounting joint provided at one end of the cylinder barrel,
the piston includes an upper mounting joint formed at an end of the piston,
the upper spherical joint includes a first spherical portion formed at a first end of the upper spherical joint, the first spherical portion being connected to the upper mounting joint of the piston to configure a spherical hinge,
the lower spherical joint includes a second spherical portion formed at one end of the lower spherical joint, the second spherical portion being connected to the lower mounting joint of the cylinder barrel to configure a spherical hinge,
the lower bracket includes a mounting portion and a bent portion bent relative to the mounting portion, the mounting portion including a fifth bolt hole formed in the mounting portion,
the bent portion includes a first opening formed in the bent portion and the lower spherical joint is mounted in the first opening,
the upper spherical joint is mounted to the upper bracket,
the first fastener includes:
a screw thread formed at a first end of the first fastener, and
a socket portion formed at a second end of the first fastener, and
the screw thread is connected to the door by passing through the first fastener hole of the hinge arm, and the upper bracket is mounted to the socket portion.

7. The universal door hinge of claim 6, wherein:
the upper spherical joint includes a screw thread formed at a second end of the upper spherical joint,
the lifting assembly further includes a connecting nut,
the upper bracket includes a second opening formed in one end of the upper bracket, and
the screw thread of the upper spherical joint passes through the second opening and is threaded with the connecting nut to mount the upper spherical joint to the upper bracket.

8. The universal door hinge of claim 6, wherein:
the first fastener further includes a flange portion disposed at a middle portion of the first fastener, the flange portion configured to be compressed against a surface of the hinge arm, and
the socket portion includes a notch formed in the socket portion, the upper bracket configured to be inserted into the notch.

9. The universal door hinge of claim 2, wherein
the hinge arm includes a single second bolt hole formed in the hinge arm, and the hinge assembly is mounted to the door by inserting the bolt into the second bolt hole and the first fastener hole.

10. The universal door hinge of claim 2, wherein
the rotation plate includes two first bolt holes formed in the rotation plate, and the hinge assembly is mounted to the vehicle body by inserting the bolts into the first bolt holes, and
the hinge arm includes two second bolt holes formed in the hinge arm, and the hinge assembly is mounted to the door by inserting the bolts into the second bolt holes.

11. The universal door hinge of claim 1, wherein
the hinge assembly is mounted to the vehicle body, and the rotation assembly and the lifting assembly are mounted to the door.

12. The universal door hinge of claim 1, wherein
the vehicle body and the door include openings for mounting the hinge assembly, the rotation assembly, and the lifting assembly, respectively.

13. A vehicle comprising the universal door hinge for the vehicle of claim 1.

14. A method of assembling a vehicle door and a vehicle body using a universal door hinge, where the universal door hinge includes a hinge assembly, a rotation assembly and a lifting assembly, the method comprising:
forming a first hole in the door to facilitate mounting of a hinge arm of the hinge assembly;
forming a second hole in the vehicle body to facilitate mounting of the rotation assembly;
forming a third hole in the vehicle body to facilitate mounting of the lifting assembly;
forming a fourth hole in the vehicle body to facilitate mounting of a rotation plate of the hinge assembly;
mounting the hinge assembly to the vehicle door by inserting a fastenter and a differently-shaped fastener into the hinge arm and the first hole, mounting the rotation assembly to the vehicle door by inserting the fastener into the second hole, mounting the lifting assembly to the vehicle door by inserting the fastener into the third hole, and rotatably connecting the hinge assembly to the rotation assembly by using a rotation pin, when the universal door hinge is used as a door hinge for a scissor door; and
mounting the hinge assembly to the door by inserting the fastener into the hinge arm and the first hole, and mounting the hinge assembly to the vehicle body by inserting the fastener into the rotation plate and the fourth hole, when the universal door hinge is used as a door hinge for a swing door.
